(19) United States
(12) Patent Application Publication
(10) Pub. No.: US 2005/0113144 A1
(43) Pub. Date: May 26, 2005

(54) Pivotal display for a mobile communications device

(76) Inventors: Amy M. Tupler, Hollywood, FL (US); Matthew R. Michieli, Gilbert, AZ (US)

Correspondence Address: AKERMAN SENTERFITT, P.O. BOX 3188, WEST PALM BEACH, FL, 33402-3188, US

(21) Appl. No.: 10/722,866

(22) Filed: Nov. 26, 2003

(51) Int. Cl. H04B 1/38

(52) U.S. Cl. 455/566

(57) ABSTRACT

A display system (105) having a pivotal and/or rotational display (110). The display system can include a platform (145), which can be in a fixed position. The display can be pivotally attached to the platform such that the display can be operable between a first position and at least a second position. Further, the display can be rotationally operable about an axis that is substantially perpendicular to a top surface of the display. Sensors (155) can be provided to detect pivot and/or rotational movement of the display.

### CROSS-REFERENCE TO RELATED APPLICATIONS

Not applicable

### FIELD OF THE INVENTION

This invention relates to mobile communication devices, and more particularly to user interfaces for mobile communications devices.

### BACKGROUND OF THE INVENTION

The use of mobile communication devices has proliferated in recent years. In addition to providing a means of voice communication, these devices often are provided with additional capabilities. For example, mobile communication devices often include text messaging and e-mail capabilities, contact management applications, calendars, integrated photo imaging, video games and other specialized applications.

In general, it is highly desirable for the mobile communication devices to be compact to easily fit into a pants pocket or small purse. Thus, the amount of space on the devices available for interface components, such as a keypads and other input devices, is limited. In consequence, a typical mobile communication device has relatively few buttons in comparison to the number of tactile inputs that may be required to utilize all of the device's features. Hence, it is often the case that certain buttons on the keypad are used to represent multiple values. When sending a text message or an e-mail, for example, one is typically required to depress a particular button multiple times to select a specific letter. Generating a text message or an e-mail in this fashion is very cumbersome.

Moreover, playing certain video games on a device having conventional keypad buttons also can be difficult. The use of the keypad buttons to perform specific tasks within a video game generally is not intuitive. Thus, a person playing the video game must direct a significant portion of his or her attention to button selection, which can diminish gratification attained from the gaming experience. Similarly, browsing the Internet using conventional mobile communications device keypad buttons can be frustrating to a novice. Accordingly, existing user interfaces fail to facilitate a more gratifying user interaction with mobile communication devices.

### SUMMARY OF THE INVENTION

An embodiment in accordance with the present invention relates to a display system having a pivotal and/or rotational display. The display system can include a platform, which can be in a fixed position. The display can be pivotally attached to the platform such that the display can be operable between a first position and at least a second position. Further, the display can be rotationally operable about an axis that is substantially perpendicular to a top surface of the display.

The display system also can include at least one sensor. The sensor can be an electrical sensor or a photon or light based sensor. An output of the sensor can correlate to the position of the display. For example, the sensor can output a signal that is used to determine a direction of display pivot, an amount of display pivot, a direction of display rotation, and/or an amount of display rotation.

The display system also can include a display support that pivotally attaches the display to the platform. The display support can include at least one support member rigidly attached to the display. The display support also can include at least one pivot member rigidly attached to the support member and pivotally attached to the platform. Further, the display system can include a structural member having at least one protrusion. The pivot member can include a channel approximately located on a circumference of the pivot member. The channel can be disposed to receive the protrusion.

In another arrangement, the display support can include at least one support member rigidly attached to the platform. The display support also can include at least one pivot member rigidly attached to the support member and pivotally attached to the display.

Further, the display can include at least one protrusion and the pivot member can include a channel approximately located on a circumference of the pivot member. The channel can be disposed to receive the protrusion.

A display lock having at least one locking member can be provided to prevent the display from pivoting when the display system is in a lock mode. The locking member can be operable between a retracted position wherein the locking member is not in contact with the display and an extended position where the locking member is in contact with the display, the contact with the display preventing the display from pivoting. The display lock can further include a display retractor that retracts the display from an extended position, where the display can be pivoted to a retracted position so the display can contact the platform. The contact with the platform can prevent the display from pivoting.

The display can pivot from the first position to the second position upon the application of a tactile force. The display can include a plurality of tension members disposed between the display and the platform. The tension members can return the display from the second position to the first position when the application of the tactile force ceases. A skirt also can be included which extends from a perimeter of the display to the platform or a surface of the device, thereby forming a barrier. The barrier can, for example, prevent contaminants such as dust and liquids from entering the display system. A graphical user interface (GUI) can present graphical information on the display and receive an input correlating to the position of the display.

Further, the invention can include a device having a display system including a platform and a display pivotally attached to the platform, the display being operable between a first position and a second position. The device can receive at least one input signal from the display system, the input signal correlating to the position of the display. The device also can include a display pivotally mounted on a support structure within the device, and means for connecting an input for the device in response to a tactile force transferred to the support structure.

### BRIEF DESCRIPTION OF THE DRAWINGS

FIG. 1 is an exemplary perspective view of a communications device having a pivotal display system which is useful for understanding the present invention.

FIG. 2 is a section view of the communications device of FIG. 1, taken along sections lines 2-2.

FIGS. 3A-3B are enlarged views of an alternate embodiment of a pivotal display system which is useful for understanding the present invention.

FIGS. 4A-4B are enlarged views of an exemplary embodiment of a pivotal display system which is useful for understanding the present invention.

FIGS. 5A-5B are enlarged views of another exemplary embodiment of a pivotal display system which is useful for understanding the present invention.

### DETAILED DESCRIPTION OF THE DRAWINGS

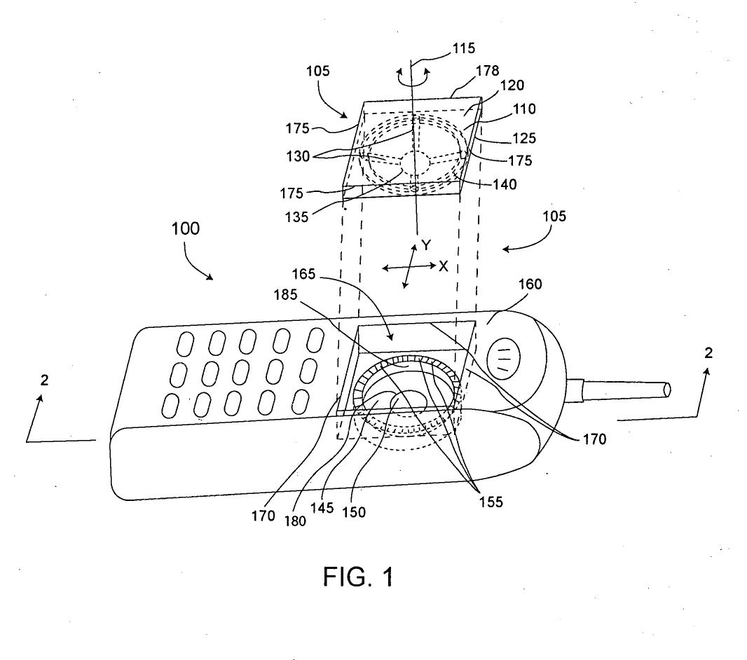

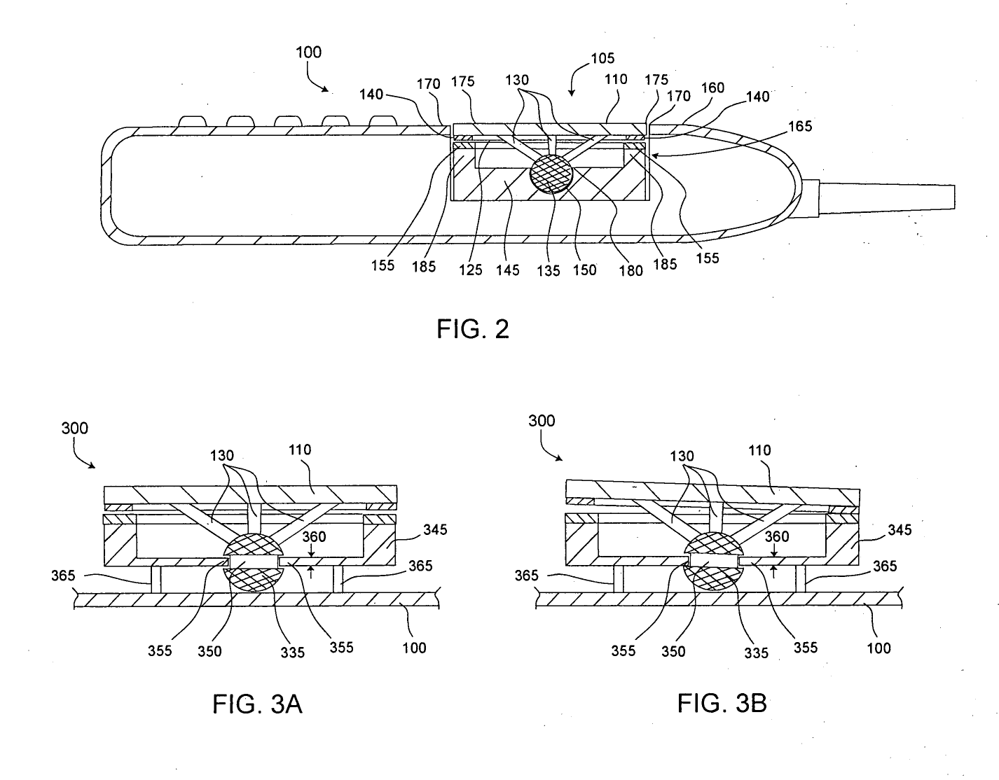

An embodiment in accordance with the present invention relates to a display system for a communications device. A perspective view of an exemplary communications device 100 is shown in FIG. 1. A section view of the communications device 100, taken along sections lines 2-2, is shown in FIG. 2. Making reference to both FIGS. 1 and 2, the communications device 100 can include a pivotal display system 105. The display system 105 comprises a display 110 that can be pivotally installed within the communications device 100. In particular, the display 110 can be pivoted by application of a tactile force. For example, the display 110 can be pivoted in an X direction, a Y direction, or any combination of X and Y directions. A tactile force also can be applied to rotate the display about an axis 115 perpendicular to a top surface 120 of the display 110. Hence, the display 110 can be pivotally and rotationally manipulated.

The use of the display system 105 can greatly improve human interaction with communications devices. For example, the display system can include a graphical user interface (GUI). The GUI can present graphical information on the display 110 and receive inputs from the display that correlate to a position in which the display is disposed. More particularly, applications can be provided for the communications device 100 which utilize the displays system's 105 pivot and/or rotational features.

For example, a text message or e-mail editor can be provided which presents each letter of an alphabet around outside edges of the display 10. To select a particular letter, a user can apply a tactile input onto the display 10 at a location where the desired letter is presented. The tactile input can cause the display to pivot in a direction defined by the tactile input. One or more sensors 155 can detect the direction of the pivot and generate an output that can be processed by a processor to supply the selected letter to the text/e-mail editor.

In another example, games can be provided for play on the communications device 100. Playing such games on the communications device 100 can be much more intuitive as compared to games which are played on other types of communications devices because the user can manipulate the display 110 to enter user commands which would otherwise be entered using a keypad. Hence, a user can focus more of her attention on the game, and divert less of her attention to key selection.

Further, using the communications device 100 to browse the Internet can be much less cumbersome as compared to using conventional communications devices. Specifically, the display 110 of the communications device 100 can be pivoted and/or rotated to navigate the Internet and scroll through web pages, as compared to using a keypad in a conventional communications device. Thus, the gratification attained from using the communications device 100 can be much greater than the gratification experienced using other communications devices. Moreover, use of the display 10 can facilitate menu selection and the implementation of other types of applications, for example drawing programs, on the communications device 100. Hence, the communications device 100 can be a multi-functional tool having far greater capability than presently available communications devices or personal digital assistants.

Notably, the communications device 100 can be any type of communications device that can transmit and/or receive a communication signal. For example, the communications device 100 can be a telephone, a mobile station, such as mobile telephone, a mobile radio, a smartphone, a personal digital assistant (PDA), a portable computer, or any other handheld communication device. In one arrangement, the communications device 100 can include a processor which can be programmed to execute software or firmware applications.

The display 110 can be any type of display that can be used with a communications device. For example, the display can be a liquid crystal display (LCD), a liquid crystal on silicon (LCOS) display, a plasma display, or any other type of compact display. The display 110 can be square, rectangular, round, oval, triangular, or any other desired shape. Further, the display 110 can be a touch or a non-touch screen display. In an arrangement where the display 110 is a touch screen, touch sensors can be disabled in regions of the display that will receive pivotal and rotational tactile forces. If the display system 105 is provided with a lock mode wherein movement of the display can be stopped (as further discussed below), the disabled touch sensors can be re-enabled during the lock mode. Alternatively, inputs from both the touch screen and from the pivotal and rotational tactile forces can be enabled, particularly (although not necessarily) in arrangements where such inputs can be made distinguishable from one another.

The display 110 can include a display support that can include one or more support members 130 rigidly attached to a bottom 125 of the display 110, and at least one pivot member 135 rigidly attached to the support members 130. The pivot member 135 can be pivotally attached to a platform 145 within the communications device 100. The display support can also include at least one support member 130 coupled or attached to the platform 145. For example, the pivot member 135 can be substantially spherically shaped and disposed within a socket 150, thereby providing for pivotal movement of the display in both the X and Y directions. The pivot member 135 can also be formed with a substantially spherical shape further including dimples for additional tactile feel for the user. The pivot member 135 and socket 150 also can provide for the rotational movement about the axis 115.

An opening 180 of a socket 150, through which the pivot member 135 can be installed, can have a smaller diameter or circumference than the diameter or circumference of the pivot member 135 to retain the pivot member 135 within the socket. In such an arrangement, the pivot member 135 can be pressed into place using a force great enough to temporarily deform the pivot member 135 and or socket 150 during the installation process. Alternatively, a retainer ring (not shown) or retaining members (not shown) can be placed over the pivot member 135 to secure the pivot member 135 within the socket 150. In another alternative, an integral lip (not shown) extending from the socket 150 can be used to retain the pivot member 135 within the socket 150.

In an alternate embodiment, the support members 130 can be rigidly attached to the platform 145 and the pivot member 135 can be pivotally attached to the display 110. In this embodiment, a socket to receive the pivot member 135 can be provided at the bottom 125 of the display 110. Nonetheless, other arrangements can be used to pivotally attach the display 110 to the platform 145, and such arrangements are within the scope of the present invention.

In an arrangement where the display 110 is round or is offset from a front surface 160 of the communications device 100, limited or unlimited rotational movement about axis 115 can be provided. In the case that the display 110 is not offset from the front surface 160 and the display 110 is not round, a degree of rotational movement about the axis 115 still can be provided. For example, a display recess 165 within the communications device 100 can be provided which has a periphery 170 that is larger than a periphery 175 of the display 110. Accordingly, a gap can be provided between the periphery 170 of the display recess 165 and the periphery 175 of the display, thereby facilitating a degree of rotational movement of the display 110 within the display recess 165.

One or more sensors 155 can be provided with the communications device 100 to detect pivotal and/or rotational movement of the display 110. The sensors 155 can be any type of sensor that can detect a position of the display 110 and/or movement of the display 110. For example, the sensors 155 can be electrical sensors, such as electrical pads. The sensors 155 also can be electro-mechanical sensors, for example mechanical structures extending from the display 110 to the platform which output a signal correlating to an amount of stretch or compression of the mechanical structures, for example a strain gauge. The sensors also can be photon or light based sensors. A photon based sensor can comprise a photon source and a photon detector. The photon based sensor can measure the location of specific portions of the display 110 relative to the sensor, and/or can measure rotational movement of the display with respect the sensor.

In one arrangement, the sensors 155 can be provided within the communications device 100 and disposed beneath the display 110. For example, the sensors 155 can be located on a raised portion 185 of the platform 145 in the display recess 165. The sensors 155 can detect movement of the display 110, for instance by monitoring movement of the display bottom 125. In another arrangement, the sensors 155 can be proximately located to, or located within, the socket 150 and detect movement of the pivot member 135 or support members 130.

In the case that the sensors 155 are electrical based sensors, a contact member can be provided to trigger a change in output states of the sensors 155. For example, a contact member 140 can be provided on a bottom surface 125 of the display 110, or a contact member can be provided on the pivot member 135. The contact member 140 can be disposed such that the contact member 140 contacts a certain one of the sensors 155 when the display 110 is pivoted in a particular direction.

Each of the electrical based sensors can be provided with a plurality of output states. For example, the sensors 155 can have two output states. A first output state of a particular sensor 155 can signify that the sensor 155 is not in contact with the contact member 140, and a second output state of a particular sensor 155 can signify that the sensor 155 is in contact with the contact member 140. Thus, whether the display is pivoted, and a direction of pivot, can be determined.

In the case that the sensors 155 are photon based sensors, the sensors 155 can measure the position of particular portions of the display 110, the contact member 135, and/or the support members 130 and generate measurement data. The measurement data can be used to compute the position of the display 110, a direction of display pivot, an amount of display pivot, a direction of display rotation, and/or an amount of display rotation.

Regardless of the type of sensors that are used, output from the sensors 155 can be processed by the processor in the communications device 100 to determine the position of the display 110. For example, in the case that the sensors are electrical touch pads, the processor can identify which, if any, of the sensors 155 are in contact with the contact member 140. In the case that photon based sensors are used, the processor can compute the display position using the measurement data from the sensors.

Referring to FIGS. 3A and 3B, enlarged views are shown of a display system 300 having an alternate pivot structure where FIG. 3A illustrates the display 110 in a neutral position and FIG. 3B illustrates the display 110 in a biased or contacting position. The display 110 can be rigidly attached to support the members 130, which can be rigidly attached to a pivot member 335. The pivot member can include a channel 350 which can receive a protrusion 355, for example a portion of a platform 345, that fits within the channel 350. In the embodiment shown, the single channel 350 can extend around a circumference of the pivot member 335. Nonetheless, the invention is not so limited. For example, one or more smaller channels which do not extend around the circumference can be disposed on the pivot member 335.

The channel 350 can have a greater width than a thickness 360 of the protrusion 355. Accordingly, the protrusion 355 can serve to maintain the display 110 within the display recess, while still allowing pivoting and rotational movement of the display 110. The platform 345 can be separated from other portions of the communications device 100 using spacing members 365 so as to allow unimpeded pivoting and rotational movement of the pivot member 335. Again, it should be noted that alternate embodiments can be implemented where the pivot member 335 is rigidly attached to the platform 345 and pivotally attached to the display 110.

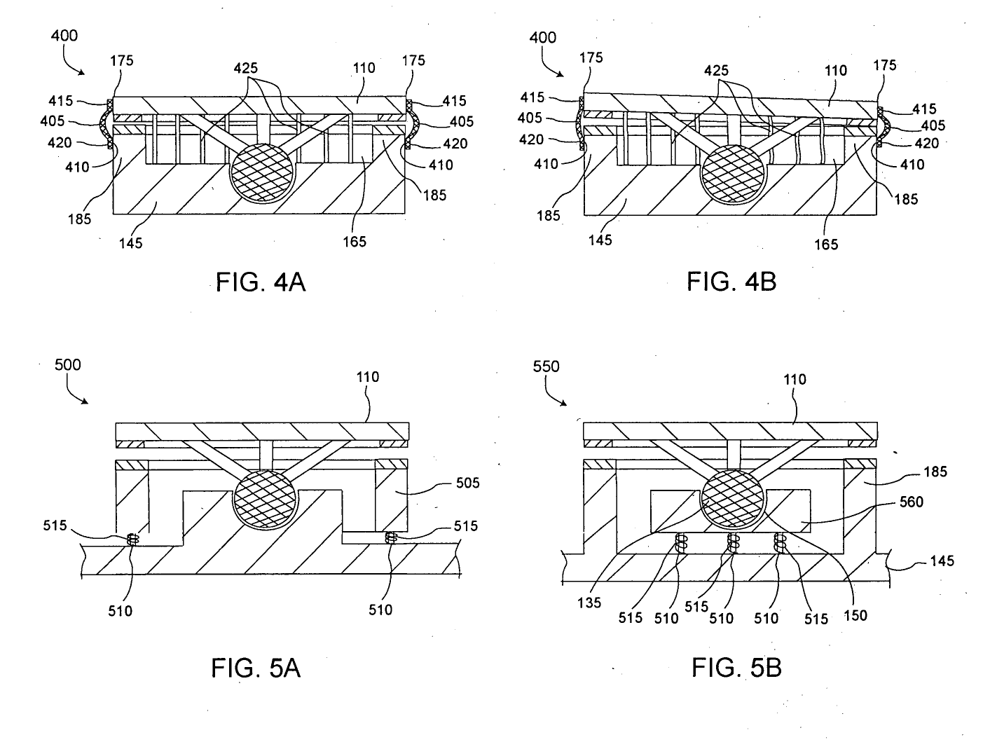

Referring to FIGS. 4A and 4B, enlarged views of a display system 400 is shown where FIG. 4A illustrates the display 110 in a neutral position and FIG. 4B illustrates the display 110 in a biased or contacting position. The display system 400 can include a skirt 405. In the embodiment where the display 110 is round or oval, the skirt 405 can extend from the periphery 175 of the display 110 to a periphery 410 of the raised portion 185 of the platform 145, as shown. In another arrangement (not shown) the skirt 405 can extend from the periphery 175 of the display 110 to the periphery of the display recess. The skirt 405 can extend completely around the periphery 175 of the display 110 and the periphery 410 of the raised portion 185 of the platform 145 (or the periphery of the display recess) so as to prevent dirt, dust, and other contaminants from entering the display recess 165. Such contaminants can interfere with proper operation of the display system 400. The skirt 405 can be secured in place using any suitable process. For instance, sides 415 and 420 of the skirt 405 can be glued or epoxied to the peripheries 175, 410 of the display 110 and platform 145, respectively.

The skirt 405 can be made of rubber, silicone, cloth or any other material which can prevent a substantial portion of contaminants from entering the display recess 165. Further, the skirt 405 can be made of a material having elasticity. Accordingly, the skirt 405 can bias the display 110 such that the display 110 returns to a neutral position when no tactile forces are being applied to the display 110. For example, in the neutral position as shown in FIG. 4A, the display can be disposed such that the contact member 140 does not contact the sensors 155. When a tactile force is applied to pivot the display 110, as shown in FIG. 4B, the skirt 405 can stretch or compress as necessary to allow for the pivot action.

Further, the display system 400 can include elastic members 425 disposed within the display recess 165 and which extend from the display 110 to the platform 145. The elastic members can be provided in addition to, or in lieu of, the skirt 405. The elastic members 425 can comprise rubber, silicone, or any other material having suitable elastic properties. The elastic members 425 also can be used to bias the display 110 such that the display 110 returns to a neutral position when no tactile forces are being applied to the display 110, as shown in FIG. 4A. When a tactile force is applied to pivot the display 110, as shown in FIG. 4B, the elastic members 425 can stretch or compress as necessary to allow for the pivot action. In one arrangement, sensors 155, for example strain gauges, can be integrated with the elastic members 425 to detect pivot and or rotation of the display 110.

In some instances it may be desirable to provide a lock mode wherein movement of the display relative to the communications device is prevented. Exemplary locking mechanisms are shown in FIGS. 5A and 5B. Referring to FIG. 5A, a display system 500 having a locking member 505 is shown. The locking member 505 can be operable between an extended position wherein the locking member 505 is seated against the display 110, thereby preventing movement of the display 110, and a retracted position in which the display 110 is free to move. One or more actuators 510 can be provided to extend and retract the locking member 505. The actuators 510 can be any type of device which can both effectuate movement of the locking member 505 and maintain the locking member 505 in a desired position. For example, the actuators 510 can be solenoids. Further, the actuators 510 can be provided with springs 515 which can apply a bias force to the locking member 505 to facilitate movement of the locking member 505 in a particular direction.

Referring to FIG. 5B, a display system 550 is shown which has locking mechanism comprising a moveable socket member 560. The socket member 560 can include the socket 150 that retains the pivot member 135. The socket member 560 can be operable between an extended position wherein the display is free to move and a retracted position wherein the display 110 is seated against the raised portion 185 of the platform 145, thereby preventing movement of the display. Again, one or more actuators 510 can be provided to extend and retract socket member 560 and the actuators can be provided with springs 515. It should be noted that the locking mechanisms disclosed herein are examples only, and that the invention is not so limited as other types of locking mechanisms can be used.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

1. A display system comprising:
a platform;
a display pivotally attached to said platform and being operable between a first position and at least a second position; and
at least one sensor;
wherein an output of said sensor correlates to said position of said display.

2. The display system of claim 1, wherein said sensor outputs a signal that is used to identify a direction of display pivot.

3. The display system of claim 1, wherein said sensor outputs a signal that is used to identify an amount of display pivot.

4. The display system of claim 1, wherein said sensor comprises at least one of an electrical contact and a photon based sensor.

5. The display system of claim 1, said display further comprising a display support that pivotally attaches said display to said platform.

6. The display system of claim 5, wherein said display support comprises:
at least one support member rigidly attached to said display; and
at least one pivot member rigidly attached to said at least one support member and pivotally attached to said platform.

7. The display system of claim 6, further comprising a structural member having at least one protrusion and said at least one pivot member comprising a channel approximately located on a circumference of said pivot member, said channel disposed to receive said at least one protrusion.

8. The display system of claim 5, wherein said display support comprises:
at least one support member attached to said platform; and
at least one pivot member rigidly attached to said at least one support member and pivotally attached to said display.

9. The display system of claim 8, said display comprising at least one protrusion and said at least one pivot member comprising a channel approximately located on a circumference of said pivot member, said channel disposed to receive said at least one protrusion.

10. The display system of claim 1, said display being rotationally operable about an axis that is substantially perpendicular to a top surface of said display.

11. The display system of claim 10, wherein said sensor measures a direction of rotation of said display.

12. The display system of claim 10, wherein said sensor measures an amount of rotation of said display.

13. The display system of claim 1, further comprising a display lock that prevents said display from pivoting when the display system is in a lock mode.

14. The display system of claim 13, wherein said display lock comprises at least one locking member that is operable between a retracted position wherein said locking member is not in contact with said display and an extended position wherein said locking member contacts said display, said locking member contact with said display preventing said display from pivoting.

15. The display system of claim 13, wherein said display lock comprises a display retractor that retracts said display from an extended position wherein said display is pivotal to a retracted position wherein said display contacts a rigid structure, said contact with said rigid structure preventing said display from pivoting.

16. The display system of claim 1, further comprising a skirt, said skirt extending from a perimeter of said display to at least one of said platform and a device surface to form a barrier.

17. The display system of claim 1, wherein said display pivots from said first position to said second position upon the application of a tactile force.

18. The display system of claim 17, further comprising a plurality of tension members disposed between said display and said platform, said tension members returning said display from said second position to said first position when said application of said tactile force ceases.

19. The display system of claim 1, wherein said platform is in a fixed position.

20. The display system of claim 1 further comprising a graphical user interface (GUI), said GUI presenting graphical information on said display and receiving at least one input correlating to which of said positions the display is disposed.

21. A device comprising a display system, the display system comprising:
a platform; and
a display pivotally attached to said platform and being operable between a first position and at least a second position;
wherein the device receives at least one input signal from the display system, said input signal correlating to which of said positions the display is disposed.

22. A device comprising:
a display pivotally mounted on a support structure within the device; and
means for connecting an input for the device in response to a tactile force transferred to the support structure.
